(19) United States
(12) Patent Application Publication
(10) Pub. No.: US 2014/0037419 A1
(43) Pub. Date: Feb. 6, 2014

(54) PROCESS FOR REACTOR CATALYST LOADING

(71) Applicants: Antonio O. Ramos, Houston, TX (US); Chithranjan Nadarajah, McLean, VA (US); Hans G. Korsten, Fairfax, VA (US); Benjamin S. Umansky, Fairfax, VA (US); Yi En Huang, North Potomac, MD (US)

(72) Inventors: Antonio O. Ramos, Houston, TX (US); Chithranjan Nadarajah, McLean, VA (US); Hans G. Korsten, Fairfax, VA (US); Benjamin S. Umansky, Fairfax, VA (US); Yi En Huang, North Potomac, MD (US)

(73) Assignee: ExxonMobil Research and Engineering Company, Annandale, NJ (US)

(21) Appl. No.: 13/957,809

(22) Filed: Aug. 2, 2013

Related U.S. Application Data
(60) Provisional application No. 61/680,003, filed on Aug. 6, 2012.

(51) Int. Cl. B01J 8/00

(52) U.S. Cl. CPC B01J 8/0015
USPC 414/800

(57) ABSTRACT

Methods, devices and processes for effectively loading catalysts into reactor vessels. In particular methods, devices and processes for effectively loading catalysts into fixed bed reactors utilizing inducted vibrational energy to improve catalyst loading performance, thereby resulting in improved flow distribution through the catalyst beds at designed operating conditions. The methods herein are particularly effectively for improving the performance of new or existing catalyst bed configurations of vertically-oriented two-phase hydroprocessing fixed bed reactors.

### CROSS-REFERENCE TO RELATED APPLICATIONS

This application claims priority to U.S. Provisional Application Ser. No. 61/680,003 filed Aug. 6, 2012, which is herein incorporated by reference in its entirety.

### FIELD

Methods, devices and processes for effectively loading catalysts into reactor vessels. In particular methods, devices and processes for effectively loading catalysts into fixed bed two-phase hydroprocessing reactor catalyst beds.

### BACKGROUND

Catalytic fixed bed reactors have been utilized for many decades in the petroleum and petrochemical refining industry (i.e., the “industry”) for upgrading raw or intermediate petroleum-based feedstocks into more valuable fuel and chemical products and base stocks. Hydroprocessing currently utilizes the largest number of fixed bed reactors in operation in the refining and petrochemical industry. Over the years, economics and competition in the industry have continued to push existing refinery hydroprocessing to ever more efficient equipment configurations and processes. In response refiners have attempted to optimize their hydroprocessing operations to 1) maximize throughput, 2) minimize operating costs (feed, catalyst, etc.), and/or 3) maximize the value of the product slates obtained from such hydroprocessing operations.

However, due to tight economics, high costs of revamping/replacing existing equipment (including extended downtime of such related equipment), and increasing more difficult and stringent permitting of new construction, the refining industry has been forced to discover new and better ways to achieve the three objectives above, while minimizing new capital costs, expenses, and limiting downtime. Additionally, since only a very small number of refineries or new petroleum hydroprocessing units are being built in either the United States or elsewhere, the vast overall majority of product production quality and quantity improvements need to be achieved through physical and process modifications, limited by the use of the existing hydroprocessing equipment.

Since new hydroprocessing reactors are an extremely costly option for an upgrade consideration for any refinery, the most of the useful improvements to existing refining hydroprocessing operations have been in either 1) improvements to the catalysts, 2) modifications to the hydroprocessing reactor internals to increase the efficiencies of the existing processes/base equipment, or 3) increase the number of beds. These options allow the main capital portion of the hydroprocessing equipment (i.e., the exiting reactors and associated equipment) to be used in the modified system, thus keeping capital cost to a minimum.

Many conventional or heritage catalytic reactors utilized in petroleum/petrochemical hydroprocessing refining are single bed reactors, while many of these processes have more than one bed in a single reactor in a “stacked bed” configuration. Most of these hydroprocessing reactors are oriented in a vertical arrangement, in that the basic shape of the reactor is cylindrical, with the axis of the cylinder oriented in the vertical direction. In the stacked bed configuration, the catalysts beds are typically vertically stacked on each other so that the feedstock flow through the reactor beds occurs in series. While multiple catalyst beds may be situated in a reactor in segmented or radially situated orientation relative to one another (i.e., from a planar view of the reactor diameter, viewed down the cylindrical axis), by far, the vast majority of catalyst beds in petroleum/petrochemical hydroprocessing reactors have single, undivided catalyst bed(s) when viewed in a plane orthogonal to the cylindrical axis of the vertical reactor.

Chemicals hydroprocessing reactors typically have diameters usually not more than 10 ft, typically 3 to 6 feet. However, while the diameters of refining hydroprocessing reactors are typically greater than about 3 feet, or about 6 feet in diameter and can range up to about 24 feet or more, but are more typically in the range of about 8 to about 30 feet in diameter, or even more typically in the range of about 8 to about 18 feet in diameter. Although not limited as such, it is to the higher diameter reactor vessels that the current invention most beneficially applies. These fixed bed hydroprocessing reactors are quite different from “tubular” reactors typically utilized in reforming operations (gas phase, such as hydrogen reforming) or the chemical industry (such as ethylene crackers) which utilize small “tube” reactors, typically less than about 6 inches in diameter.

In the petroleum and petrochemical refining industry, three (3) methods have been utilized for catalyst loading of these fixed bed reactors as described and are both well known to those of skill in the art. The first can be typically referred to as the “dump loading” method. Here, the catalyst is simply dumped into the reactor (by such devices as individual catalyst containers or buckets). Here, if the vessel is large enough, an internal worker may (not required) be located in the vessel during catalyst loading and/or after the catalyst loading is complete to assist in distributing the catalyst within the vessel. The second method is typically referred to in the industry as a catalyst “sock loading” method. In this method a flexible hose (i.e., the “sock”) is connected to the catalyst hopper and down into the reactor where a worker moves the outlet line of the hose around the internal catalyst bed as the catalyst is being fed through the hose attempting to achieve a consistent and uniform loading of the catalyst in the bed (i.e., to reduce voidages and inconsistencies, such as “bridging”, in the installed catalyst bed). In the past few decades, a third method for catalyst loading of these large catalyst bed reactors has been utilized which is called “dense loading” (or “dense bed loading”). Here, a rotary device which is temporary located in the reactor during the catalyst loading process, is utilized which obtains a feed of catalyst from the catalyst hopper, and essentially sprays the catalyst in a radial pattern into the catalyst bed during loading. The underlying principal with this process is that the catalyst (typically a uniform, extrudated catalyst with an L/D ratio of greater than one) will uniformly orient and distribute within the catalyst bed, thereby reducing inconsistencies and voidages. It has been noted in the industry that the “dense loading” process typically results in a catalyst bed loading that has a final voidage that is a few percentage points less than the voidage obtained by using either the “dump loading” or “sock loading” methods.

These three (3) processes are the standards of the industry. The best catalyst bed loading (especially in larger diameter catalyst beds) that is typically achieved is via the “dense loading” process. However, what has been discovered herein is that even with the most current and advanced dense loading technologies inefficient and non-uniform operation in commercial hydroprocessing reactors often occurs. What is need in the industry is an improved catalyst loading process for commercial hydroprocessing reactors.

### SUMMARY OF PREFERRED EMBODIMENTS OF THE INVENTION

One aspect of the invention relates to a process for loading a catalyst into a reactor vessel comprising:
loading a catalyst into a catalyst bed section of a reactor vessel;
inducing a vibration into the reactor vessel catalyst bed section at least during or after the process of loading of the catalyst into the catalyst bed section, or both;

wherein the reactor vessel has an internal diameter of at least 1 foot.

Preferably, the vibration is mechanically or acoustically induced into the reactor vessel.

In one embodiment, the vibration is mechanically induced and the mechanical means for inducing the vibration is selected from electro/mechanical and pneumatic/mechanical devices. In another embodiment, the vibration is acoustically induced and the acoustical means for inducing the vibration is selected from pneumatically driven horns and electromagnetically driven horns.

In preferred embodiments, the energy generated by the vibration is sufficient to increase the packing density of the catalyst. In yet other preferred embodiments, the vibration is mechanically induced and the energy generated by the vibration is sufficient to increase the radial uniformity of the packing density of the catalyst.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows the configuration of an actual commercial hydroprocessing reactor catalyst bed that has been dense loaded with one of the best recognized technology in the refining industry. The grey areas illustrate the locations of the upper and lower thermocouple rings in the catalyst bed.

FIGS. 2A and 2B show the actual measurements of the upper (FIG. 2A) and lower (FIG. 2B) thermocouple rings in the catalyst bed of FIG. 1.

FIG. 3 illustrates how vibrational energy is transmitted through a catalyst bed from a point source of vibration generation.

FIG. 4 illustrates an embodiment of the present invention wherein acoustical vibration devises (“acoustical horns”) are utilized from a location above the catalyst bed to generate the necessary vibrational energy into the catalyst bed.

FIG. 5 illustrates one such commercially available acoustical vibration generating device that may be used in conjunction with embodiments of the invention herein.

FIG. 6 is a schematic of the cold flow micro-reactor unit that was utilized in the testing of the Examples provide herein.

FIG. 7A is a detail of the configuration of the high efficiency liquid/gas distribution system utilized in the micro-reactor unit in the Examples herein.

FIG. 7B is a close-up detail of the distributor tray component of the high efficiency liquid/gas distribution system shown in FIG. 7A.

FIG. 8A shows the detail of the outlet pattern collector utilized in the micro-reactor to collect data of the catalyst bed outlet liquid distribution.

FIG. 8B shows a schematic view of the sixty-one (61) individual flow cells that were utilized in the outlet pattern distributor shown in FIG. 8A.

FIG. 9 graphically shows the results of the liquid distribution at the outlet of the catalyst bed from the micro-reactor for a dense loaded catalyst bed operated at varying liquid and gas flow rates per Example 1 (COLOR).

FIG. 10 graphically shows the results of embodiments of the present invention as compared to the state of the art per Example 2 (COLOR).

FIG. 11A-11C show components of the vibrational energy inducing device and their installation as utilized in, and as further described in, Example 2.

### DETAILED DESCRIPTION OF THE EMBODIMENTS

The invention as described in its preferred embodiments herein comprises methods and devices for improving the catalyst loading in “large” fixed bed reactors. Preferably, these reactors are arranged in a vertical orientation. More preferably, these reactors are essentially cylindrical in shape. The “large” fixed bed reactors utilized in conjunction with the processes of invention have an internal diameter of at least 1 foot, more preferably at least 3 feet. By the term “vertical” is meant that the vessel's longitudinal axis (i.e., the axis of its longest dimension) is in an essentially vertical orientation. For instance, where the basic shape of the reactor is cylindrical, the axis of the cylinder would be oriented in the vertical direction. In the cases herein where the term “diameter” may be used in context with a reactor vessel, it is meant to convey the term “internal diameter” unless otherwise noted. Also, in the cases herein where the term “diameter” may be used in context with a catalyst bed, it is meant to convey the term “external diameter” unless otherwise noted.

The current invention herein is preferable utilized in reactor catalyst beds that are essentially cylindrical in shape. As noted prior, as utilized herein, there may be one or more individual catalyst beds in a single reactor. These will typically be in a stacked bed configuration, wherein one bed is located at a higher vertical location with respect to the other bed or beds, the beds being situated along the cylindrical axis of the reactor. By the term “stacked”, it is only meant that the beds are oriented one on top of the other. The individual catalyst beds may or may not be separated from each other by a physical space, such as supported by individual catalyst bed supports and/or other internal reactor apparatus.

In the stacked bed configuration, the catalysts beds are typically vertically stacked on each other so that the feedstock flow through the reactor beds occurs in series. While multiple catalyst beds may be situated in a reactor in segmented or radially situated orientation relative to one another (i.e., from a planar view of the reactor diameter, viewed down the cylindrical axis), by far the oldest fixed bed reactors in the refining and chemical industry are single bed reactors, utilizing undivided catalyst bed(s) when viewed in a plane orthogonal to the cylindrical axis of the vertical reactor.

It should be noted that while the processes herein are particularly suited for loading of large cylindrical vertically oriented catalyst beds (i.e., wherein the outer diameter of the catalyst bed is essentially the same as the inner diameter, i.e., inner wall, of the reactor vessel), but it is not so limited. The methods herein may be utilized wherein (when viewed from a plane orthogonal to the vertical axis of the reactor) the catalyst bed is segmented into various sections, such as in the example of a cylindrical vertical reactor (which catalyst bed area when viewed in a plane as a circular area) wherein the catalyst bed is segmented into four catalyst bed quarters or for example two annular catalyst bed rings. Again while the preferred configuration is that the outer diameter of the catalyst bed be essentially the same as the inner diameter (i.e., inner wall) of the reactor vessel, this may not be the case such as in reactors where annular rings are present such as in the center or outer diameter of the catalyst bed for injection of gas or liquid feedstocks. Additionally, the methods as described herein are not limited to vertically oriented reactors. The methods herein are also well suited for example, to horizontal reactors, i.e., wherein the vessel's longitudinal axis (i.e., the axis of it longest dimension) is in an essentially horizontal orientation. In this case, the methods described herein in conjunction with the catalyst “sock loading” loading methods herein may be particularly beneficial. By the term “essentially the same” as used in this paragraph, it is meant that the outer diameter of the catalyst bed be at least 95% of the inner diameter of the reactor vessel.

It should be note that the terms “large reactor catalyst beds” or the like which are used in conjunction with the invention as described herein specifically excludes reactors and reactor catalyst beds that are less than 1 foot in diameter, as well as reactors/reactor shells encompassing multiple individual internal reactor tubes (generally such individual tubes are less than 2 to 4″). Such reactors are generally specialized for the generation of specific chemicals and are not included in the scope of the reactors/reactor catalyst beds as described herein in conjunction with the present invention.

As noted prior, in the petroleum and petrochemical refining industry, three main methods have been utilized for catalyst loading of these large fixed bed reactors as described and are both well known to those of skill in the art.

The first method can be typically referred to as the “dump loading” method. Here, the catalyst is simply dumped into the reactor (by such devices as individual catalyst containers or buckets). Here, if the vessel is large enough, an internal worker may (not required) be located in the vessel during catalyst loading and/or after the catalyst loading is complete to assist in distributing the catalyst within the vessel. The second method is typically referred to in the industry as a catalyst “sock loading” method. In this method a flexible hose (i.e., the “sock”) is connected to the catalyst hopper and down into the reactor where a worker moves the outlet line of the hose around the internal catalyst bed as the catalyst is being fed through the hose attempting to achieve a consistent and uniform loading of the catalyst in the bed (i.e., to reduce voidages and inconsistencies, such as “bridging”, in the installed catalyst bed). The term “voidage” as used herein, is a standard term of the art measuring the percentage of void space (i.e., space no occupied by the catalyst) per unit volume in a catalyst bed. The term “packing density” as used herein, is a standard term of the art measuring the density of the catalyst per unit volume in a catalyst bed.

The third method for catalyst loading of these large catalyst bed reactors has been utilized which is called “dense loading” (or “dense bed loading”). Here, a rotary device which is temporary located in the reactor during the catalyst loading process, is utilized which obtains a feed of catalyst from the catalyst hopper, and essentially sprays the catalyst in a radial pattern into the catalyst bed during loading. The underlying principal with this process is that the catalyst (typically a uniform, extrudated catalyst with an L/D ratio of greater than one) will uniformly directionally orient and distribute within the catalyst bed, thereby reducing inconsistencies and voidages. It has been noted in the industry that the “dense loading” process typically results in a catalyst bed loading that has a final voidage that is a few percentage points less than the voidage obtained by using either the “dump loading” or “sock loading” methods.

These three (3) processes are the standards of the industry with the most homogeneous and dense large vertical catalyst bed loading typically achieved via the dense loading process as described.

What has been discovered herein is that the even the catalyst dense loading process often results in inefficient and non-uniform operations in commercial hydroprocessing reactors. Uneven flow distribution in the reactors cause many problems, including lost catalytic conversion and selectivity efficiencies, safety problems (such as reactor hot spots than can lead to temperature runaway), shortened catalyst life, and off-specification products from the catalytic reactions. These problems associated with poor catalyst bed loading can cost refiners millions of dollars a year in lost profits, as well as contribute to unscheduled process/equipment outages and/or safety incidents. As can be seen, due to these high potential costs/losses, refiners typically pay a premium to have catalyst beds loaded via the dense catalyst loading method over the sock catalyst loading methods just to achieve marginally higher (denser) and more uniform loading of the catalyst in the beds of the reactors. However, the inventors herein have found that many commercial reactors, even when catalyst loaded via the dense catalyst loading method, can experience significant flow maldistribution during operation, again resulting in significant lost profits as have been described.

The methods described herein include the use of a means for inducing vibrations into the reactor vessel, or in embodiments to a specific part of the reactor vessel (e.g., the catalyst bed support structure) either during and/or after such reactor (or more specifically, such reactor catalyst bed volume) is loaded with catalyst. This method can specifically be utilized in conjunction with any of the three (3) noted industry methods for catalyst loading, i.e., the “dump loading”, “sock loading” or “dense loading” catalyst loading methods that have been discussed. One major difference is that when the embodiments herein are utilized with the “dump loading” or “sock loading” method, it is preferred that the vibrational energy is induced into the catalyst bed after at least a section of the catalyst bed is loaded, if an operator is utilized in the reactor vessel during the catalyst loading process. This however, can be remedied through the use of a sock that can be remotely directed within the vessel by an operator located outside of the vessel, in which case the vibrational energy can be induced into the catalyst bed while the catalyst bed is in the process of being loaded or if the vessel is small enough in diameter to allow for dump loading of the catalyst.

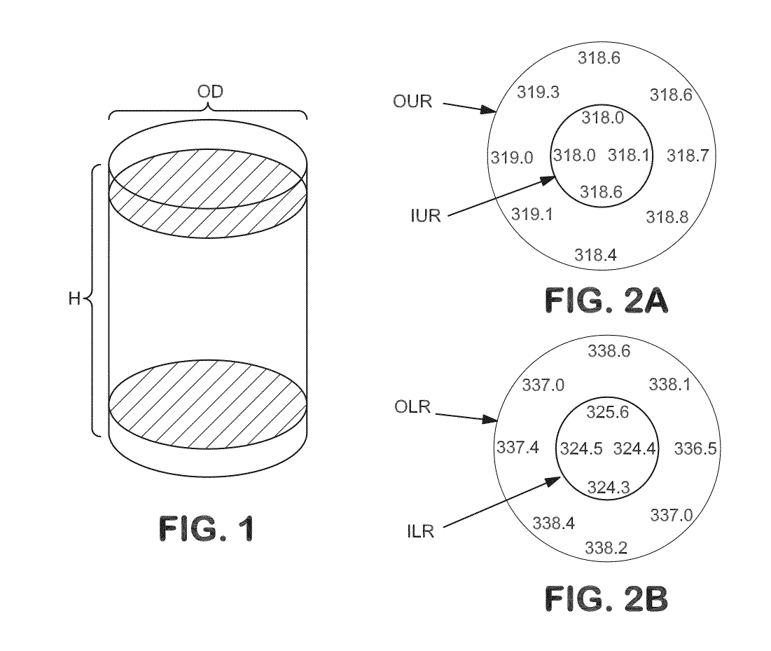

It has been discovered that even reactor beds that are carefully loaded with uniform, extrudated catalyst via the dense loading method can exhibit significant flow maldistribution. FIG. 1 herein shows the configuration of an actual commercial hydroprocessing reactor catalyst bed that had been dense loaded. The reactor catalyst bed has an outer diameter OD of 16.4 feet and a catalyst bed height H of 25 feet. This is a two-phase reactor process (i.e., two-phase gas and liquid feedstream) with the two-phase feedstream entering the top of the catalyst bed via a flow distributor (not shown) wherein the feed stream is evenly distributed across the top of the catalyst bed and flows axially through the bed and out (via hydrotreated products and gases) the bottom of the catalyst bed as shown.

The hydrotreating process is exothermic and improperly distributed flow through the catalyst bed can be indicated clearly by looking at the temperatures indicated by the bed thermocouples located radially and circumferentially in the catalyst bed during the process. FIG. 2A shows the actual bed temperatures (in ° C.) at various locations near the top of the reactor catalyst bed during operation, while FIG. 2B shows the actual bed temperatures (in ° C.) at various locations near the bottom of the reactor catalyst bed during operation. The temperatures where taken soon after the reactor was put into service and the processes and catalyst activities lined out to steady state. As can be seen in FIG. 2A, at the top of the catalyst bed, the temperatures are very uniform with an average deviation of less than about 1.5° C. In FIG. 2A, the temperatures of the outer upper ring OUR thermocouples are shown along with the temperatures of the inner upper ring IUR thermocouples. This shows that the mixing internals installed above the distributor tray are extremely efficient in providing an even temperature distribution across the top of the entire catalyst bed.

In FIG. 2B, the temperatures of the outer lower ring OLR thermocouples are shown along with the temperatures of the inner lower ring ILR thermocouples. In contrast with the upper ring thermocouples, when viewing the simultaneous temperature readings from FIG. 2B near the bottom of the catalyst bed, it can be seen that while the temperatures in the inner ring of thermocouples differ less than about 2° C., that the difference between the temperatures between the inner and outer thermocouple rings near the bottom of the catalyst bed significantly differed by approximately 13° C. This indicated that there was significant flow maldistribution in the catalyst bed even after the dense loading of the catalyst bed. Additionally, the data indicates that the uniformity of the catalyst loading via the dense loading process appears to have an inherent “radial maldistribution” aspect. That is the catalyst loading uniformity (or lack thereof) appears to change as a function of the radial distance across the bed. This results in an annular flow maldistribution problem in the reactor in that it suggests that there is a maldistribution of gas and liquid flow between the inner and outer portion of the catalyst bed. Alternatively, the two phases of the feedstream may be preferentially “separating” radially along the catalyst bed. In either case, this results in inefficient hydroprocessing reactor operation and non-optimized product conversion.

In embodiments of the processes herein, it has been discovered that catalyst uniformity and catalyst bed flow uniformity can be improved if vibrations are induced into the catalyst bed and supporting structures during and/or after the catalyst bed loading process. This can also be perform for a portion of the catalyst bed loading process wherein a particular catalyst bed is loaded in steps, or wherein separate catalyst are loaded in a single bed, one on top of the other. In these latter cases, the processes can be performed during and/or after each catalyst loading “step” or “section”. Any conventional or new method of catalyst loading process, such as the “dump loading”, “sock loading” or “dense loading” catalyst loading methods, can be used in conjunction with the processes herein.

In embodiments herein, such vibrations may be induced either mechanically (electro or pneumatically driven), acoustically, or both, by apparatus connected to the reactor or preferentially connected to specific components of the reactor vessel. Although a single device may be used to induce such vibrations, preferably more than one device will be attached to the reactor in order to more evenly distribute the vibration energy throughout the catalyst bed. Preferred mechanical devices for inducing vibrational energy into the reactor catalyst bed include: electro/mechanical and pneumatic/mechanical vibrational devices. These devices may either be attached directly to the shell or other structural components of the reactor, such as catalyst bed supports, or they may be hand held devices (such as vibrating wands) which can be inserted into the catalyst bed to induce vibrations therein. Preferred acoustical devices for inducing vibrational energy into the reactor catalyst bed include: air horns, sonic horns, and acoustic horns. While pneumatically driven horns are preferred, the selection sonic and acoustic horns may alternatively comprise the selection of electromagnetically driven horns. In preferred embodiments, the mechanical devices for inducing vibrational energy create vibrational frequencies from about 30 to about 600 Hz, more preferably from about 60 to about 420 Hz. The amplitudes and energies of the vibrational energy inducing devices selected can vary depending on the geometry and volume of the catalyst bed, as well as the number and location(s) of the devices utilized in practicing the invention.

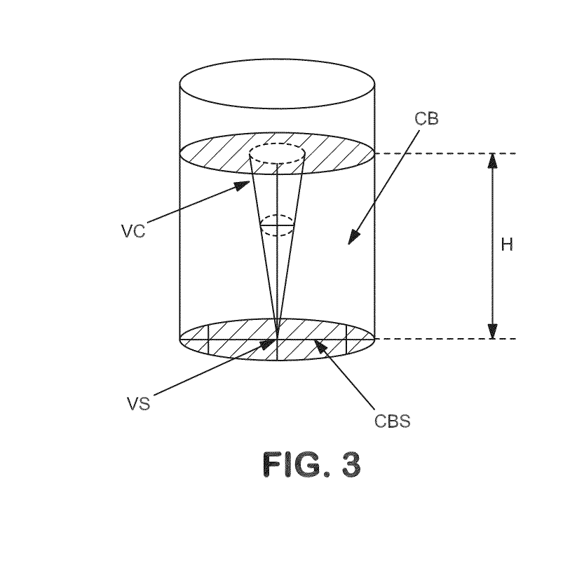

FIG. 3 illustrates how vibrational energy is typically transmitted through the catalyst bed and/or reactor structure from a point source. Such vibrational energy as shown can be produced either mechanically or acoustically. As can be seen in the figure the vibrational energy will move through the catalyst bed (i.e., a particle bed) via a “vibration cone” VC which is emanating from a single vibration source VS thereby transmitting the vibration energy through the height H of the catalyst bed CB. Vibrational energy can also be transmitted through a portion of the reactor structure, such the catalyst bed support CBS (as indicated in FIG. 3), which in turn can distribute the vibrational energy more uniformly across and throughout the catalyst bed. A preferred method herein is to attach the mechanical vibration generating device(s) to, and/or aim the acoustical vibration generating device(s) at, internal structures of the reactor, such as the catalyst bed support or evenly along the walls of the reactor, in order to evenly distribute the vibrational energy into the catalyst bed during and/or after the catalyst loading process. Another preferred method is to orient multiple vibration generating device(s) such that the “vibration cones” overlap in order to create more uniform distribution of the vibrational energy in the catalyst bed.

In some embodiments of the invention, the electro/mechanical and/or pneumatic/mechanical vibrational devices may be hand held devices such as vibrating wands) which can be inserted into the catalyst bed to induce vibrations therein. Here, an operator working inside the vessel can use the device to induce vibrations directly into discrete sections of the catalyst bed. This can be performed while catalyst bed loading is being performed, after sections of the catalyst bed loading have been completed, and/or after the catalyst bed loading is complete.

In preferred embodiments, the vibrational devices are attached directly to the shell of the reactor and/or they may be attached to other structural components of the reactor, such as, but not limited to, the catalyst bed supports, internal structural support rings, or to the external vessel support(s) themselves. When a mechanical means for inducing the vibration is utilized, it is preferred that the device is attached to at least one of the following reactor vessel components: reactor wall, catalyst bed support beams, internal structural support rings, outlet collector, vessel flanges, vessel manways, and vessel external supports. Alternatively, the mechanical means for inducing the vibration may be a handheld vibrational device which is not attached to the reactor vessel or components, but is instead utilized by an operator within the reactor vessel. When an acoustical means for inducing the vibration is utilized, it is preferred that the device is attached to at least one of the following reactor vessel components: catalyst bed support beams, internal structural support rings, distributor tray, vessel flanges, and vessel manways.

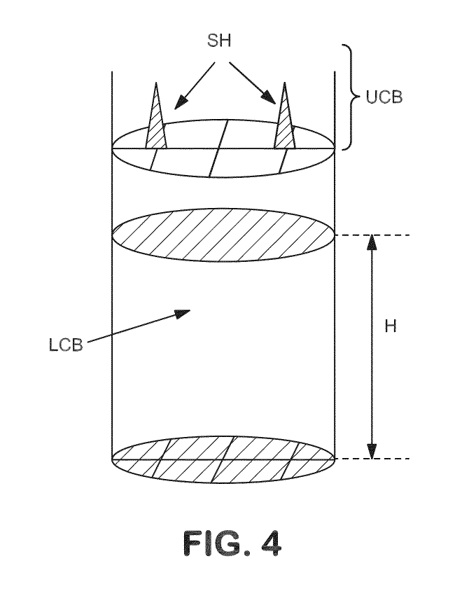

As shown in FIG. 3, a preferred location for inducing the vibrational energy is on the bottom of the catalyst bed support structure. Here, the devices can be installed prior to beginning loading of the catalyst bed and can afterward be easily removed through manways located in the vessel wall or bottom head. Conversely, if the reactor has multiple stacked bed sections, the vibrational device(s) can be attached to or located at the catalyst bed support structure above the targeted catalyst bed. An example of this configuration is illustrated in FIG. 4, where acoustical horns SH are shown mounted on the upper bed catalyst support structure and aimed down into the lower catalyst bed. Conversely, for the upper catalyst bed, such acoustical horns can be located on the top head of the vessel through manways and other openings are be supported inside the upper section of the reactor vessel above the upper catalyst bed. After completing the catalyst loadings per the methods described herein, the vibrational devices can be removed, preferably prior to the reinstallation of the reactor flow distributor located above the top catalyst bed.

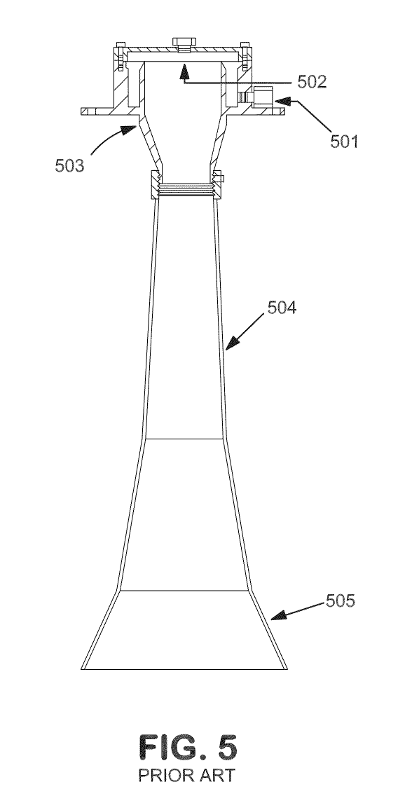

FIG. 5 herein illustrates one such commercially available acoustical horn as may be used in conjunction with the present invention. One benefit associated with the use of acoustical horns is that they are easy to install and utilize within the reactors, and do not need to be in physical contact with the catalyst bed or the associated support structures in order to induce the necessary vibrational energy into the catalyst bed necessary to achieve the improved catalyst loadings associated with this invention. FIG. 5 shows a particular advantageous type of acoustical horn which is an “air horn”, “acoustic horn”, or “sonic horn”. The horn is comprised of a compressed air inlet 501 which operates a diaphragm 502 and driver 503 assembly to create high levels of acoustical energy. A significant benefit with this type of vibrational device is that it can produce very high levels of vibrational energy in a compact device. It is also air operated which makes installation into the reactor vessels both simple and safe. Continuing with the diagram in FIG. 5, the air horn is further comprised of a bell 504 and an outlet 505 which are designed to help amplify and directionally focus the transmission of acoustical vibration energy which is beneficial to the application of the present invention.

In preferred embodiments herein, the vibrational energy is induced into the catalyst bed section of the reactor vessel in steps of increasing amplitudes followed by steps of decreasing magnitudes. Alternatively, the amplitudes may be increased followed by the decrease as described in a continuous, as opposed to step wise, manner. Although not so limited herein, this method is believed to be particularly effective in further improving the installation of the catalyst bed, and its resulting improved flow distribution properties, when utilized either after a particular catalyst bed has been loaded with catalyst, or alternatively, after a portion of a particular catalyst bed has been loaded with catalyst.

The processes herein are preferably for use in catalyst loading of “large” fixed bed reactors. These are reactors having an internal diameter of typically at least 1 to 3 feet. These are differentiated from “tube bundle” reactors, which are reactors with multiple catalyst tubes or sets of tubes in which the catalyst is inserted. The tubes of these tube bundle reactors are often externally heated (such as in hydrogen reforming) and radial heat transfer in the catalyst beds is poor. In order to transfer the required heat between the fluids inside the tubes and the heat transfer fluids outside the tubes, the tubes are typically less than 3 inches in diameter, more commonly on the order of 1 to 2 inches. These tubes do not have the flow distribution problems as experienced in the larger reactor vessels as described in embodiments of this invention and do not utilize either sock loading or dense loading techniques as described herein for large fixed bed reactors. Neither of these catalyst loading processes can be utilized for loading tube bundle reactors. In preferred embodiments herein, the internal diameter of the reactor vessel is at least 1 foot, or at least 3 feet, or at least 6 feet, or at least 10 feet, or at least 15 feet. It has been discovered the methods herein are particularly effective for reactor vessels with an internal diameter of from about 3 to about 6 feet, and reactor vessels with an internal diameter of at least 15 feet. Particularly in these size reactor ranges, it has been discovered that the dense loading process tends to produce non-uniform loadings results, especially in radial non-uniformities, as were discussed in conjunction with the findings in existing commercial reactors exemplified in FIGS. 1, 2A and 2B above.

It has been discovered that flow maldistribution takes place more frequently in reactors with either very small or very large reactor diameter. Reactors with higher length/diameter ratios (i.e., “L/D ratio”) of greater than about 3 may also be more susceptible to maldistributed catalyst loadings. When the term “L/D” is used in the context of a reactor vessel herein, the L/D ratio is measured with the dimension L being determined along the longest central axis of the reactor vessel from the vessel tangent-to-tangent lines, and with the dimension D being determined as the maximum internal wall dimension of the reactor vessel as measured along an axis perpendicular to the L axis. In the case of a common cylindrical reactor with elliptical heads on each end, the dimension L would the length of the reactor between the two tangent lines along the axis of the cylinder, and the dimension D would be the internal diameter of the reactor vessel measured in a plane orthogonal to the cylinder axis. Preferably the method utilized herein is utilized in reactor vessels with L/D ratios greater than about 5, even more preferably greater than about 7.

In preferred embodiments, the catalyst is a pelletized catalyst (preferably extruded). The catalysts lend themselves particularly well to the processes of invention. Some examples of preferred catalyst shapes are as follows: spherical spheroidal, ring, cylindrical, trilobe, and quadralobe.

Preferably the catalyst particle is in an elongated form; that is that the catalyst particles have a length/diameter ratio (i.e., “L/D ratio”) of greater than 1. More preferably, the catalyst pellets have an average L/D ratio of from about 1 to about 8, and even more preferably from about 2 to about 6. When the term “L/D” is used in the context of a catalyst herein, the L/D ratio is measured with the dimension L being determined by the maximum dimension of the catalyst along any axis of the catalyst, with the dimension D being determined as the maximum dimension of the catalyst measured along an axis perpendicular to the L axis. When using a catalyst pellet with an L/D ratio of greater than about 1, or even more particularly, of about 2 or greater, it is preferred that the processes herein are utilized in conjunction with the dense loading process, particularly when the reactor vessel has an internal diameter of at least about 8 feet, or even 12 feet or more.

It is believed herein that these methods of invention herein are particularly beneficial in improving reactor catalyst bed flow distributions in two-phase fixed bed reactor vessels. In a two-phase reactor process, the feedstream is a mixture of at least one gas phase component and at least one liquid phase component. Such flowstreams/feedstreams are typical in large hydroprocessing reactors used in the processing of base and intermediate stock hydrocarbon feedstreams in petroleum and petrochemical refineries. These processes include: hydrotreating, hydrodesulfurization, hydrodenitrogenation, hydrodemetalation, hydrogenation, hydroisomerization, and hydrocracking processes. In these processes, a hydrocarbon based liquid feedstream is mixed with a hydrogen containing gas stream and then exposed to the catalyst in the reactor vessel to produce an improved product slate. Typically such processes are useful in removing sulfur and other contaminants from hydrocarbon feedstreams (e.g., hydrodesulfurization, hydrodenitrogenation, or hydrodemetalation processes), reducing the average boiling point of hydrocarbon feedstreams (e.g., hydrocracking processes), and/or modifying the hydrocarbon compounds in the hydrocarbon feedstreams (e.g., hydrogenation or hydroisomerization processes). In each of these processes, specific types of catalysts will be utilized depending upon the feedstream composition and the product compositions to be sought.

Preferred hydroprocessing operating conditions for reactor vessels targeted by the methods of invention herein include two-phase flow including one or more of the following conditions: a temperature of at least about 260° C., for example at least about 300° C.; a temperature of about 425° C. or less, for example about 400° C. or less or about 350° C. or less; a liquid hourly space velocity (LHSV) of at least about 0.1 hr⁻¹, for example at least about 0.3 hr⁻¹, at least about 0.5 hr⁻¹, or at least about 1.0 hr⁻¹; an LHSV of about 10.0 hr⁻¹ or less, for example about 5.0 hr⁻¹ or less or about 2.5 hr⁻¹ or less; a hydrogen partial pressure in the reactor from about 200 psig (about 1.4 MPag) to about 3000 psig (about 20.7 MPag), for example about 400 psig (about 2.8 MPag) to about 2000 psig (about 13.8 MPag); a hydrogen to feed ratio (hydrogen treat gas rate) from about 500 scf/bbl (about 85 Nm³/m³) to about 10000 scf/bbl (about 1700 Nm³/m³), for example from about 1000 scf/bbl (about 170 Nm³/m³) to about 5000 scf/bbl (about 850 Sm³/m³).

The Examples included herein were developed and run based on comparative testing of conventional catalyst loading processes and embodiments of the catalyst loading methods of the invention herein. The Examples shown herein clearly show the benefits embodiments of the present invention over the prior art techniques. Such benefits are shown and explained in further detail in the Examples herein.

### OTHER PREFERRED EMBODIMENTS

Additionally or alternately, the invention can include one or more of the following embodiments.

### Embodiment 1

A Process for loading a catalyst into a reactor vessel Comprising:
loading a catalyst into a catalyst bed section of a reactor vessel;
inducing a vibration into the reactor vessel catalyst bed section at least during or after the process of loading of the catalyst into the catalyst bed section, or both;

wherein the reactor vessel has an internal diameter of at least 1 foot.

### Embodiment 2

The process of embodiment 1, wherein the vibration is mechanically or acoustically induced into the reactor vessel.

### Embodiment 3

The process of embodiment 2, wherein the vibration is mechanically induced and the mechanical means for inducing the vibration is selected from electro/mechanical and pneumatic/mechanical devices.

### Embodiment 4

The process of embodiment 2, wherein the vibration is acoustically induced and the acoustical means for inducing the vibration is selected from pneumatically driven horns and electromagnetically driven horns.

### Embodiment 5

The process of any of embodiments 1-3, wherein the vibration is mechanically induced and the energy generated by the vibration is sufficient to increase the packing density of the catalyst.

### Embodiment 6

The process of any of embodiments 1-3 and 5, wherein the vibration is mechanically induced and the energy generated by the vibration is sufficient to increase the radial uniformity of the packing density of the catalyst.

### Embodiment 7

The process of any of embodiments 1, 2 and 4, wherein the vibration is acoustically induced and the energy generated by the vibration is sufficient to increase the packing density of the catalyst.

### Embodiment 8

The process of any of embodiments 1, 2, 4 and 7, wherein the vibration is acoustically induced and the energy generated by the vibration is sufficient to increase the radial uniformity of the packing density of the catalyst.

### Embodiment 9

The process of any prior embodiment, wherein the vibrations are induced at a frequency of from about 60 to about 420 Hz.

### Embodiment 10

The process of any prior embodiment, wherein the catalyst is in a uniform pelletized or extruded catalyst shape.

### Embodiment 11

The process of any prior embodiment, wherein the catalyst is selected from spherical spheroidal, ring, cylindrical, trilobe, and quadralobe shapes.

### Embodiment 12

The process of any prior embodiment, wherein the L/D ratio of the catalyst is from 1 to 8.

### Embodiment 13

The process of any prior embodiment, wherein the reactor vessel is a hydroprocessing reactor.

### Embodiment 14

The process of any prior embodiment, wherein the reactor vessel further comprises an inlet distributor.

### Embodiment 15

The process of any prior embodiment, wherein the reactor vessel has an internal diameter of at least 3 feet.

### Embodiment 16

The process of any prior embodiment, wherein the reactor vessel is a vertical reactor and has an L/D ratio of at least 5.

### Embodiment 17

The process of any prior embodiment, wherein the reactor vessel material is selected from steel and steel alloys.

### Embodiment 18

The process of any prior embodiment, wherein the reactor vessel is designed for two-phase hydrocarbon hydroprocessing.

### Embodiment 19

The process of any of embodiments 3, 5, 6 and 9-18, wherein the mechanical means for inducing the vibration is attached to at least one of the following reactor vessel components: reactor wall, catalyst bed support beams, internal structural support rings, outlet collector, vessel flanges, vessel manways, and vessel external supports.

### Embodiment 20

The process of any of embodiments 3, 5, 6 and 9-18, wherein the mechanical means for inducing the vibration is a handheld vibrational device.

### Embodiment 21

The process of any of embodiments 4 and 7-18, wherein the acoustical means for inducing the vibration is attached to at least one of the following reactor vessel components: catalyst bed support beams, internal structural support rings, distributor tray, vessel flanges, and vessel manways.

### Embodiment 22

The process of any prior embodiment, wherein the loading of the catalyst into the reactor vessel is accomplished by either the catalyst dump loading method or the catalyst sock loading method.

### Embodiment 23

The process of any of embodiments 1-22, wherein the loading of the catalyst into the reactor vessel is accomplished by the catalyst rotary dense loading method.

### Embodiment 24

The process of any of embodiments 3, 5, 6, 9-20, 22 and 23, wherein the vibration is mechanically induced at least during the process of loading of the catalyst into the reactor vessel.

### Embodiment 25

The process of any prior embodiment, wherein the vibration is induced after the process of loading at least a portion of the catalyst into the reactor vessel, wherein the vibration amplitude if successively increased and then decreased.

### Embodiment 26

The process of any prior embodiment, wherein the external diameter of the catalyst bed section of the reactor vessel is essentially the same as the internal diameter of the reactor vessel.

### Embodiment 27

The process of any prior embodiment, wherein the vibration is induced into the catalyst bed section of the reactor vessel in steps of increasing amplitudes followed by steps of decreasing magnitudes.

### Embodiment 28

The process of any prior embodiment, wherein the process of inducing vibrations into the catalyst bed section of the reactor vessel in steps of increasing amplitudes followed by steps of decreasing magnitudes is performed after the process of loading of the catalyst into the catalyst bed section is complete.

### EXAMPLES

### Testing Apparatus

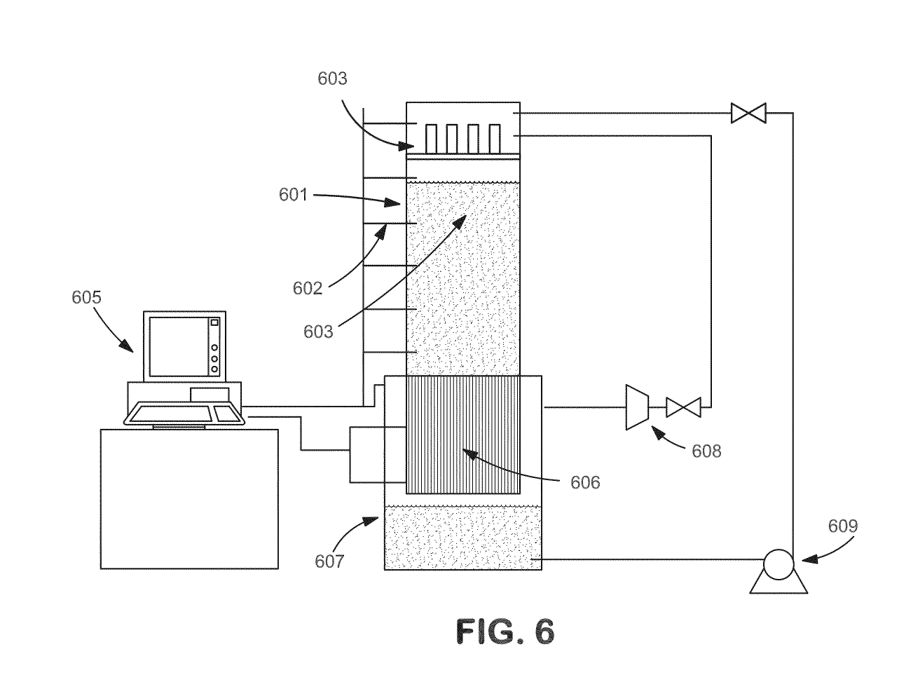

A laboratory scale, cold-flow reactor unit was fabricated to test the concept of embodiments of the present invention. The reactor unit that was utilized in the testing associated with these examples is shown schematically in FIG. 6. The unit contained a laboratory scale, cold flow reactor (“reactor”) 601 which housed a catalyst bed 602. The overall reactor height was about 4 meters, m (about 157.5 inches, in) and the reactor was about 56 centimeters, cm (about 22 inches, in) in diameter. The reactor contained a typical extrudated hydroprocessing catalyst with a quadralobe characteristic shape and approximately 1.3 mm nominal size. Since this reactor was only used for cold-flow testing (i.e., flow distribution testing), the catalytic material composition of the actual catalyst utilized is not relevant to the testing herein.

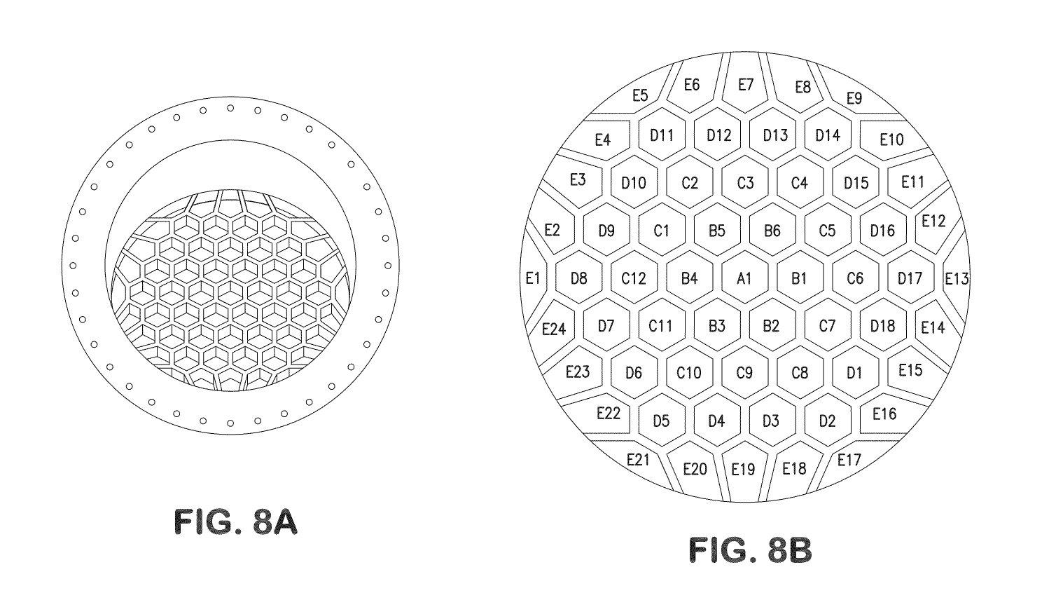

The reactor contained a high efficiency liquid/gas flow distribution system with distributor tray 603 to ensure very even mixing and flow distribution of the two-phase feed (liquid and gas) to the top of the catalyst bed 601. Intra-bed probes 604 were installed at various levels in the reactor to monitor pressure drop across the catalyst bed. The data from the intra-bed probes was continuously monitored and fed into a data acquisition system 605. The distribution of liquid flow was semi-continuously monitored and recorded via an outlet pattern collector 606 attached to the bottom of the reactor. The outlet pattern collector 606 monitored the real-time liquid flow distribution through the catalyst bed via sixty-one (61) individual flow cells each with the identical cross-sectional square area (as is illustrated in FIG. 8B). The real-time liquid flow distribution through these sixty-one (61) individual flow cells was semi-continuously monitored and fed into a data acquisition system 605.

The gas phase flow was collected at the top of the reactor outlet reservoir 607 and recycled back during the testing via a gas recycle compressor loop 608. In a similar fashion, the liquid phase flow was collected at the bottom of the reactor outlet reservoir 607 and recycled back during the testing via a liquid recycle pump loop 609. During testing, nitrogen was utilized as the feed gas phase component and an iso-paraffin hydrocarbon solvent mixture was utilized as the feed liquid phase component.

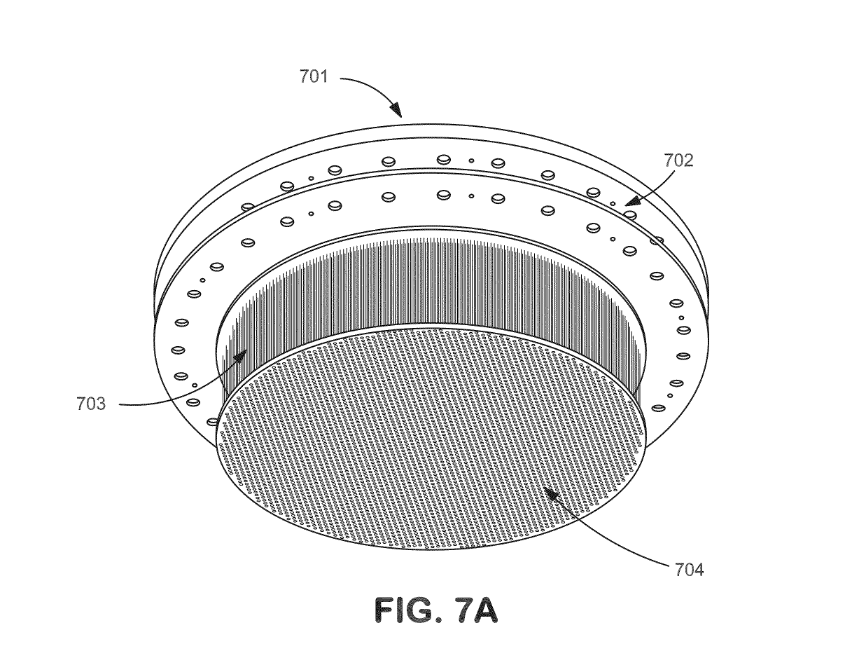

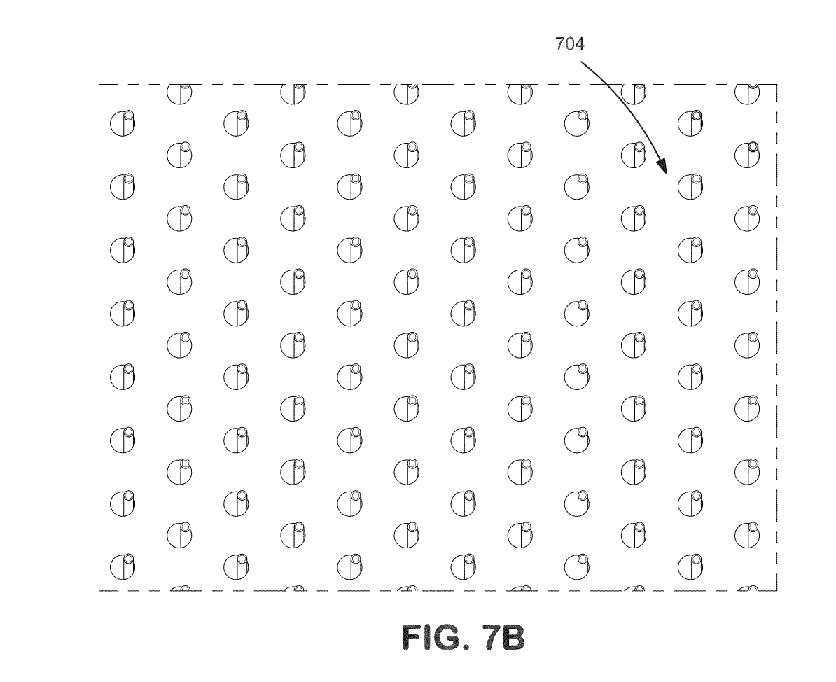

FIG. 7A shows a detail of the configuration of the high efficiency liquid/gas flow distribution system with distributor tray utilized in the reactor (i.e., same as element 603 in FIG. 6) while FIG. 7B shows a closeup view of the distributor tray component. Here, the liquid phase 701 and the gas phase 702 were each fed into the top of the distribution system. The liquid was distributed through the tubes 703 and tray 704 arrangement while the gas phase was distributed through the gaps between the tubes and the distributor tray. In this manner, a very even two-phase flow distribution was achieved at the inlet (i.e., top) of the reactor catalyst bed.

FIG. 8A shows a detail of the configuration of the outlet pattern collector utilized in the reactor (i.e., same as element 606 shown in FIG. 6) while FIG. 8B shows a schematic view of the sixty-one (61) individual collector flow cells. Each if these sixty-one (61) individual collector flow cells has the same cross sectional area in order to accurately measure the flow distribution from the outlet of the reactor catalyst bed.

This testing apparatus was used in all of the following examples described herein.

### Example 1

### Reactor Unit Flow Testing/Analysis

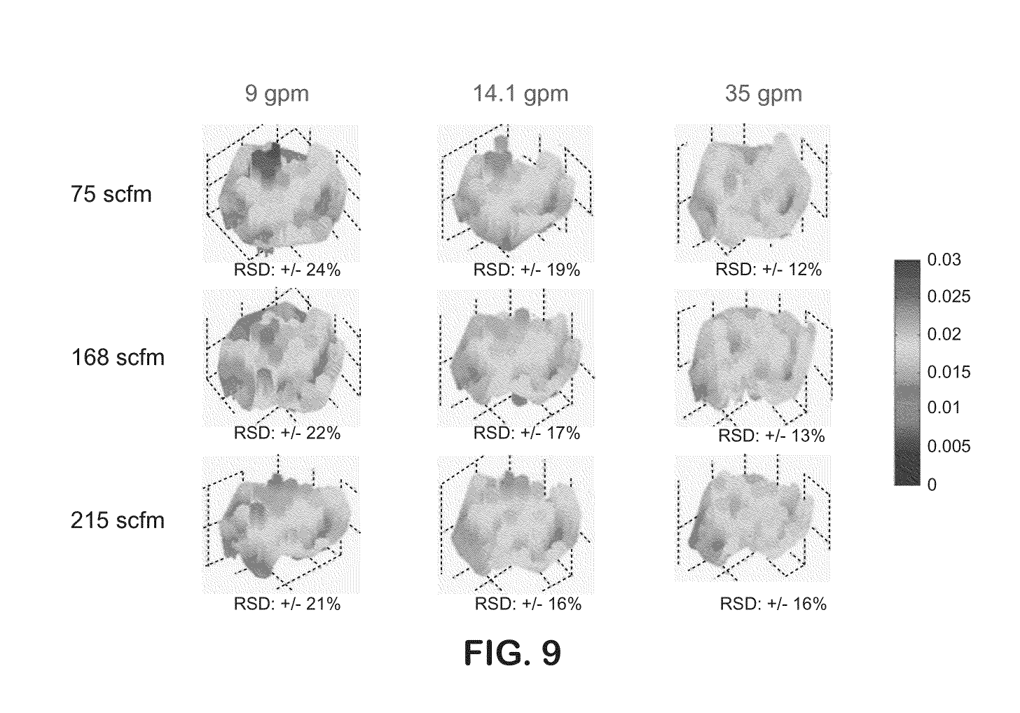

In this example, the catalyst was loaded into the reactor via an industry dense loading method to a bed height of 1 meter, m (39.4 inches, in). The reactor system was run various two-phase flow conditions, with the liquid flow being varied at 9 gpm, 14.1 gpm, and 35 gpm (horizontal axis in FIG. 9), and the gas flow being varied at 75 scfm, 168 scfm, and 215 scfm (vertical axis in FIG. 9). As such, a total of nine (9) various runs were made under standard catalyst dense loading conditions.

The results of these tests are shown in FIG. 9. Each of these figures graphically shows the liquid flow distribution at the outlet of the catalyst bed. In the figures, areas in red indicate sections with high flow rates, while areas in blue indicate sections with low flow rates. An even coloring (i.e., consistent green/yellow across the overall bed outlet) would indicate an essentially even flow distribution.

As can be seen, the effects of liquid flow maldistribution due to non-optimal dense catalyst loading appear to be a further function of flow rate with the higher flow rates showing lesser effects of liquid flow maldistribution.

The Relative Standard Deviation (RSD) shown for each case equals the standard deviation (STDEV) divided by the mean flow rate (MEAN) based on the flow through each of the sixty-one (61) individual flow cells of the outlet pattern collector located at the outlet of the catalyst bed.

### Example 2

### Comparative Embodiments of the Invention

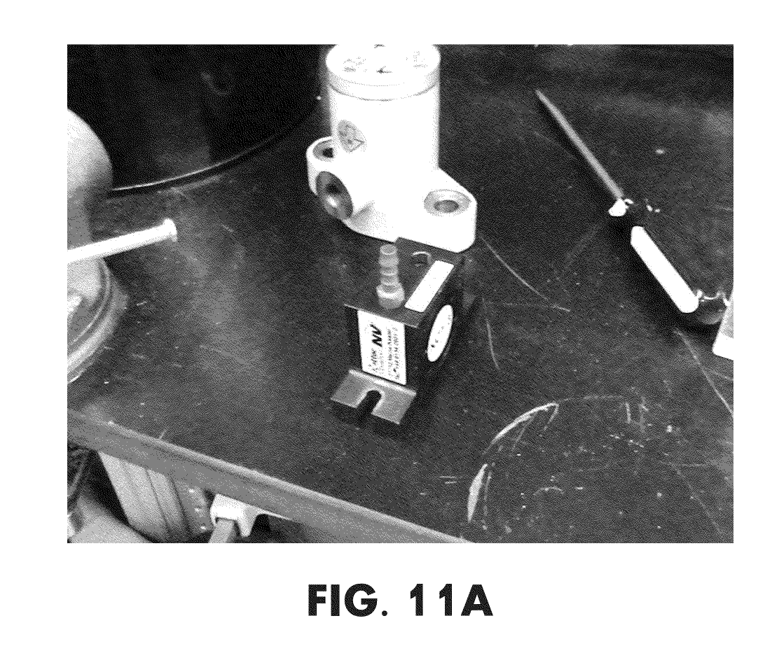

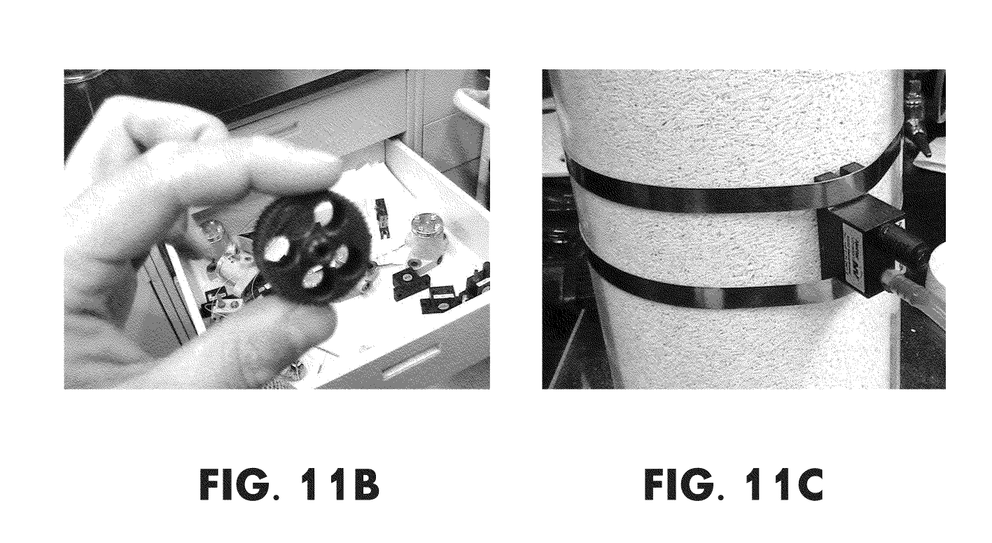

In this example, the unit was set up in the same configuration as in Example 1, except that an air-driven mechanical (i.e., pneumatic/mechanical) vibration inducing device as shown in FIG. 11A was attached to the unit to induce vibrations during and/or after catalyst loading. The vibration inducing device consisted of an air inlet, an off-balanced center wheel (see FIG. 11B), and a protective housing. The vibration inducing device was attached to the shell of the reactor (as shown in FIG. 11C) with an air hose attached to the air inlet of the vibration device. In each of the four (4) cases in this example, the catalyst was loaded into the reactor to a bed height of 1 meter, m (39.4 inches, in).

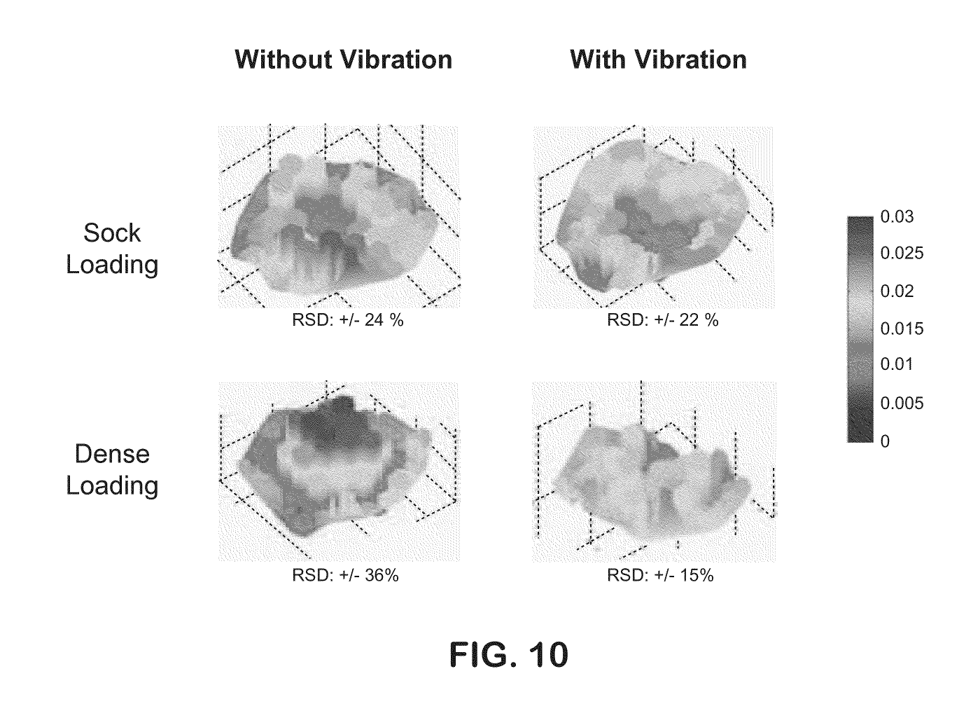

In the first case, the catalyst was loaded into the reactor via the “sock loading” method without vibrations being induced. The results of the reactor cold flow testing associated with this case are shown in the upper left hand corner of FIG. 10.

In the second case (embodiment of the invention) the catalyst was loaded into the reactor via the “sock loading” method and then vibrations were induced after the conventional loading process was completed. This was done in an effort to simulate commercial operations wherein the vibrations could not be induced while an operator was in the vessel facilitating the sock loading process. The results of the reactor cold flow testing associated with this case are shown in the upper right hand corner of FIG. 10.

In the third case, the catalyst was loaded into the reactor via the “dense loading” method without vibrations being induced. The results of the reactor cold flow testing associated with this case are shown in the lower left hand corner of FIG. 10.

In the fourth case (embodiment of the invention) the catalyst was loaded into the reactor via the “dense loading” method while vibrations were being induced during the conventional loading process. This was done in an effort to simulate commercial operations wherein the vibrations could be induced while the dense loading process was in progress. As noted prior, the dense loading process is operated remotely with no operator located in the reactor vessel. The results of the reactor cold flow testing associated with this case are shown in the lower right hand corner of FIG. 10.

The reactor system was run under one two-phase flow condition in all four (4) cases of this example, with the liquid flow at 14.1 gpm and the gas flow at 168 scfm (mid-range of the prior Example 1).

As can be seen in the cold flow reactor system comparative results shown in FIG. 10, the vibrations clearly and significantly improved the liquid flow distribution in both cases (second and fourth cases). It is not clear whether the smaller improvement associated with the inducement of vibrations associated with sock loading are attributable mainly to the sock loading process or the fact that the vibrations were induced after the loading process was complete. It is believed herein that simultaneous sock loading and inducement of vibrations (i.e., as in remotely controlled sock loading) would exhibit even more improved results.

It can be seen that the case of simultaneous use of vibrational energy with the dense loading resulted in significant improvements in the reactor flow distribution. As shown in the two comparative figures at the bottom of FIG. 10, the use of vibrational energy during the dense loading process reduced the reactor flow maldistribution by about one-half. This is a significant improvement over the prior art technology.

While the present invention has been described and illustrated by reference to particular embodiments, those of ordinary skill in the art will appreciate that the invention can lend itself to variations not necessarily illustrated herein. For this reason, then, reference should be made solely to the appended claims for purposes of determining the enforceable scope of the present invention.

What is claimed is:

1. A process for loading a catalyst into a reactor vessel comprising:
loading a catalyst into a catalyst bed section of a reactor vessel;
inducing a vibration into the reactor vessel catalyst bed section at least during or after the process of loading of the catalyst into the catalyst bed section, or both;
wherein the reactor vessel has an internal diameter of at least 1 foot.

2. The process of claim 1, wherein the vibration is mechanically or acoustically induced into the reactor vessel.

3. The process of claim 2, wherein the vibration is mechanically induced and the mechanical means for inducing the vibration is selected from electro/mechanical and pneumatic/mechanical devices.

4. The process of claim 2, wherein the vibration is acoustically induced and the acoustical means for inducing the vibration is selected from pneumatically driven horns and electromagnetically driven horns.

5. The process of claim 2, wherein the vibration is mechanically induced and the energy generated by the vibration is sufficient to increase the packing density of the catalyst.

6. The process of claim 5, wherein the vibration is mechanically induced and the energy generated by the vibration is sufficient to increase the radial uniformity of the packing density of the catalyst.

7. The process of claim 2, wherein the vibration is acoustically induced and the energy generated by the vibration is sufficient to increase the packing density of the catalyst.

8. The process of claim 7, wherein the vibration is acoustically induced and the energy generated by the vibration is sufficient to increase the radial uniformity of the packing density of the catalyst.

9. The process of claim 3, wherein the vibrations are induced at a frequency of from about 60 to about 420 Hz.

10. The process of claim 4, wherein the vibrations are induced at a frequency of from about 60 to about 420 Hz.

11. The process of claim 1, wherein the catalyst is in a uniform pelletized or extruded catalyst shape.

12. The process of claim 11, wherein the catalyst is selected from spherical spheroidal, ring, cylindrical, trilobe, and quadralobe shapes.

13. The process of claim 12, wherein the L/D ratio of the catalyst is from 1 to 8.

14. The process of claim 1, wherein the reactor vessel is a hydroprocessing reactor.

15. The process of claim 1, wherein the reactor vessel has an internal diameter of at least 3 feet.

16. The process of claim 15, wherein the reactor vessel is a vertical reactor and has an L/D ratio of at least 5.

17. The process of claim 1, wherein the reactor vessel material is selected from steel and steel alloys.

18. The process of claim 1, wherein the reactor vessel is designed for two-phase hydrocarbon hydroprocessing.

19. The process of claim 16, wherein the reactor vessel is designed for two-phase hydrocarbon hydroprocessing.

20. The process of claim 3, wherein the mechanical means for inducing the vibration is attached to at least one of the following reactor vessel components: reactor wall, catalyst bed support beams, internal structural support rings, outlet collector, vessel flanges, vessel manways, and vessel external supports.

21. The process of claim 3, wherein the mechanical means for inducing the vibration is a handheld vibrational device.

22. The process of claim 4, wherein the acoustical means for inducing the vibration is attached to at least one of the following reactor vessel components: catalyst bed support beams, internal structural support rings, distributor tray, vessel flanges, and vessel manways.

23. The process of claim 1, wherein the loading of the catalyst into the reactor vessel is accomplished by either the catalyst dump loading method or the catalyst sock loading method.

24. The process of claim 1, wherein the loading of the catalyst into the reactor vessel is accomplished by the catalyst rotary dense loading method.

25. The process of claim 3, wherein the loading of the catalyst into the reactor vessel is accomplished by the catalyst rotary dense loading method.

26. The process of claim 23, wherein the vibration is mechanically induced at least during the process of loading of the catalyst into the reactor vessel.

27. The process of claim 25, wherein the vibration is mechanically induced at least during the process of loading of the catalyst into the reactor vessel.

28. The process of claim 23, wherein the vibration is induced after the process of loading at least a portion of the catalyst into the reactor vessel, wherein the vibration amplitude if successively increased and then decreased.

29. The process of claim 1, wherein the vibration is induced into the catalyst bed section of the reactor vessel in steps of increasing amplitudes followed by steps of decreasing magnitudes.

30. The process of claim 29, wherein the process of inducing vibrations into the catalyst bed section of the reactor vessel in steps of increasing amplitudes followed by steps of decreasing magnitudes is performed after the process of loading of the catalyst into the catalyst bed section is complete.
